(19) United States
(12) Patent Application Publication
(10) Pub. No.: US 2014/0259994 A1
(43) Pub. Date: Sep. 18, 2014

(54) Building Architecture for Residential Dwelling

(71) Applicant: Douglas Dale Lenberg, Farmington, NM (US)

(72) Inventor: Douglas Dale Lenberg, Farmington, NM (US)

(21) Appl. No.: 13/834,783

(22) Filed: Mar. 15, 2013

(51) Int. Cl. F17D 1/08; E04B 1/94; A62C 3/00; G06F 17/50

(52) U.S. Cl. CPC F17D 1/08; G06F 17/5004; E04B 1/941; A62C 3/00
USPC 52/168; 703/1; 137/561 R

(57) ABSTRACT

A system that facilitates water conservation and energy savings for a residential dwelling or home is provided. The system will increase the efficiency with which water is consumed by implementing a reclamation system for reusing water for selected tasks. Energy savings are enabled by utilizing unique insulating materials that allow the climate of the interior of a home to be controlled in a more affordable manner as less fuel/energy is required to heat/cool the home's interior.

### CROSS-REFERENCE TO RELATED APPLICATION

This application claims the benefit of priority of U.S. patent application Ser. No. 13/589,816 filed Aug. 20, 2012, which claimed the benefit of the priority of provisional application No. 61/524,846, filed Aug. 18, 2011, the contents of which are all incorporated herein by reference thereto.

### BACKGROUND OF THE INVENTION

1. Field of the Invention

The present invention relates to residential dwelling and, more particularly, to conserving energy and water in a residential dwelling and the usage of a Hydra computer software program in designing a plumbing system that has unique capabilities with regard to a balanced plumbing system, integrally having unique fire suppression capabilities.

2. Description of Prior Art

Currently, mankind is dependent on fossil fuels which are not inexhaustible. Therefore, the search is on to find technologies that can maximize the available energy resources. Renewable energy sources are abundant but mechanisms to tap into this energy source are inefficient.

Conservation of energy would greatly assist in reducing our need for fossil fuels. Renewable energy will not replace fossil fuels at the rate we are consuming. However, if the consumption of energy is lowered on an individual basis, renewable energy may become more viable because the supply of the renewable energy would then be able to sustain a house. At these reduced consumption levels existing renewable energies will work and will replace fossil fuels.

As can be seen, there is a need for a residential dwelling that enables conservation of energy and water.

Patent Application Publication Number 2008/0041364 of James R. Brock published on Feb. 21, 2008 for an Energy Efficient Building Design which discloses an energy efficient housing and to a method of providing an energy efficient housing wherein building material and house structure aim to provide a system effectively using external temperature for house needs. The house is built of multilayered blocks having layers of concrete and layer of mixture of concrete, cellulose fiber and sand surrounded with exterior and interior stucco finish layers prepared by a simplified process. The concrete layer has a plurality of air passages with baffles used for transferring of hot and cool air which change the temperature from the house walls and roof heated with sun radiation or cooled by cold outside air. The hot air is transferred to a hot air reservoir for further household needs and cool air is transferred to a cold air reservoir.

This reference is deficient in that it references utilization of air exchanges to control the interior of a building environment which in and of itself leads to health hazards. It also doesn't control floor surface temperatures which is where people walk. It is highly inefficient and terribly uncontrollable. It is NOT a plumbing system of any kind and has absolutely nothing to do with moving fluids for heating or cooling. The capacities of this system in high desert applications are extremely limited leaving very unhappy occupants.

U.S. Pat. No. 5,406,657 of William R. Donati issued on Apr. 18, 1995 for a Water recycling device for flush toilet use discloses a compact, modular gray water recycling system includes a control and reservoir unit for storing gray water, which is received from a source such as a sink drain, and is pumped to the household toilet as necessary. The single unit houses a pump, flow signals, filters, and an overflow, as well as a liquid level actuating device for signaling when the liquid level has fallen to below a designated level. The system also utilizes a second storage reservoir and a second control unit for adding gray water from the second reservoir to the control and reservoir unit in response to a signal indicating low water level therein. The secondary storage units may also be adapted to receive water from an outside source such a rainfall runoff.

This reference is deficient in that it is not an integral part of the buildings plumbing reclamation system. It is also limited by the fact that untreated water becomes septic after 24 hours of being untreated and therefore by code is NOT allowed to be used in a UPC or IPC approved plumbing system interior to a building It is also deficient in that it is limited to flushing toilets. By definition this reference is included in the EPA Standard and Environmental Health standards and is in fact not a plumbing system for reclamation of water to used inside and outside of the building. This system does not recognize the uses applicable to a plumbing reclamation system.

### SUMMARY OF THE INVENTION

An exemplary embodiment of a building architecture of the includes a plumbing system, a heating system and an insulation system. The plumbing system includes a reclamation tank for reusing water; and the heating system includes a solar panel system, a radiant floor and a heat exchanger; and the insulation system includes wrapping the house with insulating materials.

### BRIEF DESCRIPTION OF THE DRAWINGS

FIG. 1 is a schematic of an exemplary embodiment of a plumbing system of the invention.

FIG. 2 is a schematic view of an exemplary embodiment of a heating system of the invention.

FIG. 3 is a schematic view of an exemplary embodiment of a side of a home of the invention

FIG. 4 is an exemplary embodiment of a layout of a house of the invention.

FIG. 5 is an exemplary embodiment of a four port plumbing fitting #100 with plumbing piping #102 attaching to all four ports and interior to #100 four port body is a threaded receptacle.

### DETAILED DESCRIPTION OF THE INVENTION

### The Best Mode of the Invention

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

### How to Make the Invention

Broadly, an embodiment of the present invention provides a system for managing water use and the climate of a home. The system integrates a plumbing based cold water and fire system and a plumbing waste system that reclaims water and enables a user to recycle that water for particular tasks and an insulation system for a home that enables a user to use much less fuel to heat/cool the home. The plumbing based cold water and fire system is also connected to the fire protection system as described in U.S. Pat. No. 6,044,911 to Haase which is hereby incorporated by reference.

Referring to FIG. 1, a schematic of the plumbing waste system is displayed. reclaimed-water from sinks and showers is fed into the system via 10. An open ball valve 16 controls the flow of water to the bypass to the sewer 12. A closed ball valve 18 controls the flow of water from 10 to the WL-55 26. The WL-55 26 is a water reclamation system. Closed ball valve 18 regulates the flow of water to supply toilets 22. A check valve 18 enables fresh water to pass through open ball valve 16 and fresh water bypass 24 for the toilets. Water to the drain to the sewer 30 is regulated by a closed ball valve 18.

The water-reclamation system treats the reclaimed water and purifies it so that it can be used for more than flushing toilets. The treated reclaimed water can be used to water plants.

FIG. 2 is a schematic of a house with installed elements for regulating the heat in the house. The solar panels 46 are used in conjunction with the solar thermal heat exchanger 44 and the heat exchanger 42 to provide heat to the house. A pump 38 is connected to a boiler 36 to deliver a steady supply of water to the boiler 36. The bypass 34 is also connected to the pump 38.

FIG. 3 is a schematic of a side of the building illustrating a wall, floor and a roof. The foundation 62 extends below the finish grade 60. The insulation and exterior wall assembly 58 may include any exterior siding such as a stucco system 56.

### How to Use the Invention

The insulation system completely wraps the house on the outside of the framing. The insulation is installed under the concrete floor of the slab, or the basement of the house if applicable. The insulation is also used to cover the top of the house, including the attic. The insulating material is made from expanded mylar coated polystyrene. This method of insulation completely envelopes the house, and eliminates all thermal bridging. Thermal bridging is a result of the way conventional homes are insulated. In a conventional home, insulation is put between the studs and roof joists before the exterior siding is put on. In conventional insulation the insulation is put between the top floor ceiling joist which leaves the attic area cold. The trouble with this method is that the wood joist contacts the outside siding and cold comes through the wood into the home. The insulation method of the invention prevents the wood joist from coming into contact with the cold.

Additionally, since the insulation is attached to the outside of the framing, a different stud size can be used for the construction. The studs required with this new type of insulation coupled with the insulation technique are typically 2′.times.4″ studs in an exemplary embodiment of the invention. The conventional practices primarily utilize 2″.times.6″ studs to fit the insulation in.

FIG. 4 illustrates the layout 64 of a house in an exemplary embodiment of the invention. The house features a bedroom 66, a bath 68, a master bedroom 70, the kitchen 72, a living room 74, a utility room 76, a toilet 78, another bath 80, a bathroom sink 82, a kitchen dish washer 84, a kitchen sink 86, a washer 88, a reclamation water tank 90 and discharge to the garden 92.

### How to Adapt the Invention to Modern Home Construction Methods

The utilization of Expanded Polystyrene (EPS), in various thicknesses, with Mylar facing in lieu of traditional building wrap materials, constitutes a unique way to construct an Energy Efficient Building Envelope. EPS material itself cannot be claimed, but the unique method and my copyrighted reports from Sandia National Laboratories and Los Alamos National Laboratories show the uniqueness of the “results” of this methodology. In essence, by limiting thermal bridging the required energy for heating and cooling this home has been reduced. The significant reduction in energy requirements allows for a much smaller more efficient renewable energy source that is now affordable for the average person. Imagine a Styrofoam cup in your hand and someone is pouring boiling hot coffee into the cup. It does not adversely affect your hand. So current architecture would benefit from being wrapped in Expanded Polystyrene. The extreme heat of the desert southwest would not have as bad an effect on the building. It would be stopped from entering the building through thermal bridging.

Utilizing the scientific data supplied by the manufacturer of the EPS, and having this data confirmed by Sandia National Laboratories and Los Alamos National Laboratories, in conjunction with certain heating calculation software programs, this type of construction reduces energy requirements by a minimum of 50%. In some cases it has reduced energy requirements by 75%. The research home located at 4636 Piedras Street in Farmington N. Mex. is a good example. Another example is a home located at 503 Skyline in Elephant Butte N. Mex.

Computer designed heating system, which when used in conjunction with our building design, requires less energy allowing for the installation of Solar Thermal Panels which utilize the suns radiant energy to heat fluids such as glycol, which when pumped through a heat exchanger assembly, gives off heat for domestic hot water usage such as, but not limited to, bathing, showering, laundry, etc. Due to the architectural design, the capabilities of the Solar Thermal System, include primary radiant floor heating, utilizing the same Solar Thermal Panels (see diagram). Utilization of Solar Thermal heating Panels for Domestic/Radiant primary heating/cooling systems make this type of system extremely affordable.

The benefits of this Real Green Building System will reduce costly infrastructure for new sub-divisions by at least 50% for every municipality where they are utilized. The system eliminates the need for fire hydrants, fire stations and more importantly fire department personnel.

The system will reduces personnel costs to each municipality by at least 50% in the Fire Services category. Personnel costs and retirement benefits cost will be greatly reduced.

The usage of this system will reduce water infrastructure costs to the municipality by at least 50%. Water storage capacities will be cut significantly. Millions of dollars in taxpayer monies will be saved.

The usage of this system will make Photo-voltaic energy producing systems affordable for every persons new home by lowering the energy needs by at least 50%.

The living environment of each building created using this system will be healthier than a standard building. These buildings will cut health care costs from sick building syndrome significantly. An internal controlled healthy environment will result in lower health care costs.

It should be understood, of course, that the foregoing relates to exemplary embodiments of the invention and that modifications may be made without departing from to spirit and scope of the invention as set forth in the following claims.

What is claimed is:

1. A method for designing a plumbing system comprising the steps of: entering data about the building to be fitted to;
entering data related to the plumbing system; enter data related to the plumbing system legal requirements to be met by the building; entering data related to the fire suppression requirements for the building; enter data related to the unique capabilities with regard to a balanced plumbing system; entering data related to the integral fire suppression capabilities desired; and
using a computer to print out a layout of a plumbing system for the construction personnel to follow in installing the system in a building.

2. A method for designing a plumbing system according to claim 1 wherein the system supplies all cold water plumbing fixtures in a balanced way.

3. A method for designing a plumbing system according to claim 1 wherein the system simultaneously providing available water flow to fire sprinkler assemblies.

4. A method for designing a plumbing system according to claim 1 wherein the design for the plumbing system allows for the collection of certain, previously used, water, that is collected in the drains of bath, shower, lavatories, laundry and any future plumbing assemblies.

5. A method for designing a plumbing system according to claim 1 wherein the used water is collected into a tank.

6. A method for designing a plumbing system according to claim 1 wherein the collected water is cleaned by a chemical process.

7. A method for designing a plumbing system according to claim 6 wherein the chemical process includes use of a material selected from the group consisting of Hydrogen Peroxide, Halogen Oxides, Ultra Violet Light, or Alcohols.

8. A method for designing a plumbing system according to claim 1 wherein the resulting water can be reused for flushing of toilets.

9. A method for designing a plumbing system according to claim 1 wherein the resulting water can be reused for external usage at the building, such as irrigation, watering of shrubs, trees, or grass.

10. A method for designing a plumbing system according to claim 1 wherein the resulting system can collect and reuse over 50% of the initial incoming water to a particular building.

11. A method for designing a plumbing system according to claim 1 wherein the system includes heating and cooling for the building.

12. A method for designing a plumbing system according to claim 1 wherein the resulting system reduces infrastructure costs by 50%.

13. A method for designing a plumbing system according to claim 1 wherein the resulting system reduces the personnel costs by 50% in fires services needed by the building.

14. A method for designing a plumbing system according to claim 1 wherein the resulting system reduces water infrastructure costs to the municipality by at least 50%.

15. A method for designing a plumbing system according to claim 1 wherein the resulting system improves the living environment of each residence created using this system by being healthier than any prior art building.

16. A plumbing system comprising: a networked system; the networked system includes utilizing a common plumbing system supplying fixtures and fire sprinklers; where each sprinkler is supplied by at least three different paths of plumbing.

17. A plumbing system according to claim 16 wherein the design for the plumbing system allows for the collection of certain, previously used water, that is collected in the drains of bath, shower, lavatories, laundry and any future plumbing assemblies.

18. A plumbing system according to claim 16 wherein the used water is collected into a tank.

19. A plumbing system according to claim 16 wherein the collected water is cleaned by a chemical process.

20. A plumbing system according to claim 19 wherein the chemical process includes use of a material selected from the group consisting of Hydrogen Peroxide, Halogen Oxides, Ultra Violet Light, or Alcohols.

21. A plumbing system according to claim 20 wherein the resulting water can be reused for flushing of toilets.

22. A plumbing system according to claim 20 wherein the resulting water can be reused for external usage at the building, such as irrigation, watering of shrubs, trees, or grass.

23. A plumbing system according to claim 16 wherein the resulting system can collect and reuse over 50% of the initial incoming water to a particular building.

24. A plumbing system according to claim 16 wherein the system includes heating and cooling for the building.

25. A plumbing system according to claim 16 wherein the resulting system reduces infrastructure costs by 50%.

26. A plumbing system according to claim 16 wherein the resulting system reduces the personnel costs by 50% in fires services needed by the building.

27. A plumbing system according to claim 16 wherein the resulting system reduces water infrastructure costs to the municipality by at least 50%.

28. A plumbing system according to claim 16 wherein the resulting system improves the living environment of each residence created using this system by being healthier than any prior art building.
